(19) United States
(12) Patent Application Publication
(10) Pub. No.: US 2021/0021175 A1
(43) Pub. Date: Jan. 21, 2021

(54) CAN FOR AN ELECTRIC MACHINE MADE FROM A FIBER COMPOSITE MATERIAL, ELECTRIC MACHINE, AND PRODUCTION METHOD

(71) Applicant: Rolls-Royce Deutschland Ltd & Co KG, Blankenfelde-Mahlow (DE)

(72) Inventors: Izabela Kuder, Erlangen (DE); Robert Goraj, Erlangen (DE)

(21) Appl. No.: 16/968,745

(22) PCT Filed: Feb. 7, 2019
(86) PCT No.: PCT/EP2019/053016

§ 371 Date: Aug. 10, 2020

(30) Foreign Application Priority Data
Feb. 13, 2018 (DE) 10 2018 202 192.9
May 3, 2018 (DE) 10 2018 206 787.2

(51) Int. Cl. H02K 9/197

(52) U.S. Cl. CPC H02K 9/197

(57) ABSTRACT

The disclosure relates to a can for an electric machine, wherein the can is configured to be arranged between a stator and a rotor of the electric machine. The can is produced at least partially from a fiber composite material, which has a matrix and a plurality of fibers, wherein the plurality of fibers include first fibers produced from an electrically conductive first material and second fibers produced from a second material having a lower electrical conductivity in comparison to the first material. The first fibers and the second fibers of the plurality of fibers are arranged relative to one another in such a way that the respective first fibers are spaced apart from one another.

The present patent document is a § 371 nationalization of PCT Application Serial No. PCT/EP2019/053016, filed Feb. 7, 2019, designating the United States, which is hereby incorporated by reference, and this patent document also claims the benefit of German Patent Application No. 10 2018 202 192.9, filed Feb. 13, 2018, and German Patent Application No. 10 2018 206 787.2, filed May 3, 2018, which are also hereby incorporated by reference.

### TECHNICAL FIELD

The present disclosure relates to a can for an electric machine, wherein the can is configured to be arranged between a stator and a rotor of the electric machine. The can is manufactured at least partially from a fiber composite material which has a matrix and a plurality of fibers. In this case, the plurality of fibers includes first fibers which are manufactured from an electrically conductive, first material. The present disclosure further relates to an electric machine including a can of this kind. The present disclosure also relates to a method for producing a can of this kind.

### BACKGROUND

Cans for electric machines are of interest in the present case. Cans of this kind are used in liquid-cooled electric machines, in particular, and are arranged there between the stator and the rotor in the air gap. The can has a sealing function there by way of preventing the cooling liquid from entering the air gap. It is known from the prior art to form a can of this kind from an electrically conductive material, for example, a metal or a carbon fiber-reinforced plastic. The technical problem consists in induced eddy currents and the resulting power losses in the electric machine which result from the use of the electrically conductive material in the magnetic air gap region. In particular, the can is exposed to changing magnetic fields so that, when the can is made of an electrically conductive material, these induced eddy currents are generated and are converted into heat. This power loss therefore results in an increase in the temperature of the component.

In order to achieve a higher specific (e.g., in terms of density) rigidity and strength, cans composed of a carbon fiber-reinforced plastic have also been used in addition to the metal cans. In this case, the disadvantage of the eddy currents arising due to the electrical conductivity of the fibers was accepted in view of the very good mechanical properties. Unidirectional layers reinforced with carbon fibers have very good mechanical properties in the fiber direction, wherein the electric current is also conducted in this direction. In addition, there is electrical contact between the individual electrically conductive fibers in the microstructure of a unidirectional layer of this kind. This also results in closing of the circuit in the direction transverse in relation to the fiber direction. This leads to eddy currents which flow both transversely and longitudinally in relation to the fiber direction. This causes additional electromagnetic losses, wherein the temperature of the can increases due to the released electrical heat. The formation mechanism of eddy currents also applies to angular positions whose fiber direction differs from the circumferential direction of the electric machine.

### SUMMARY AND DESCRIPTION

The object of the present disclosure is to provide a solution as to how the eddy current losses may be reduced in the case of a can which is manufactured from a fiber composite material.

According to the disclosure, this object is achieved by a can, by an electric machine, and by a method as described herein. The scope of the present disclosure is defined solely by the appended claims and is not affected to any degree by the statements within this summary. The present embodiments may obviate one or more of the drawbacks or limitations in the related art.

A can for an electric machine is configured to be arranged between a stator and a rotor of the electric machine. The can is manufactured at least partially from a fiber composite material which has a matrix and a plurality of fibers. In this example, the plurality of fibers includes first fibers manufactured from an electrically conductive, first material. Furthermore, the plurality of fibers includes second fibers manufactured from a second material having a low electrical conductivity in comparison to the first material. Furthermore, the first fibers and the second fibers are arranged in relation to one another in such a way that the respective first fibers are spaced apart from one another.

A can of this kind may be used in an electric machine and, in particular, in a liquid-cooled electric machine. The can may be of substantially hollow-cylindrical design. Given the intended arrangement of the can in the electric machine, the can is in the air gap between the stator and the rotor. The stator may be sealed off from the air gap with the aid of the can. This may prevent the cooling liquid, which is located in the stator and is used there in particular for cooling the coils of the stator, from entering the air gap. The can is at least partially manufactured from a fiber composite material which has a plurality of fibers or fiber bundles. In particular, the can is manufactured entirely from the fiber composite material. In the fiber composite material, the fibers are embedded in a matrix.

According to the present disclosure, the fiber composite material has two types of fibers or fiber bundles. Firstly, the fiber composite material includes the first fibers which are formed from the first, electrically conductive material. Furthermore, the fiber composite material includes the second fibers which are formed from the second material. This second material has a lower electrical conductivity than the first material. In particular, the second material is an electrically insulating material or an electrical insulator. The first fibers and the second fibers may each include a plurality of individual fibers. In this example, it is further provided that the matrix or the matrix material has a low electrical conductivity and in particular is of electrically insulating design. In this example, it is provided that the first fibers and the second fibers are arranged in relation to one another in such a way that the respective first fibers are spaced apart from one another. The electrically conductive first fibers or fiber bundles are woven in a weave with the second fibers such that electrical contact between the first fibers is prevented. A hybrid fabric concept which has the first fibers and the second fibers is introduced in this way. Therefore, current propagation in the transverse direction or a direction perpendicular in relation to the fiber direction of the first fibers may be suppressed. In this way, the formation of eddy currents in the can may be prevented.

The first fibers may be arranged parallel in relation to one another along a direction. In particular, it is provided that all of the first fibers are arranged along the direction. In addition, some of the second fibers are likewise arranged along the direction. In this example, at least one second fiber is arranged between adjacent first fibers in each case. Therefore, the situation that the first fibers are arranged in a manner spaced apart from one another and therefore are not in electrical contact with one another may be achieved in a simple manner.

In a further embodiment, the first fibers and the second fibers form a fabric layer in which second fibers are additionally arranged along a transverse direction which is perpendicular in relation to the direction. In addition to the abovementioned second fibers which are arranged along the direction between the first fibers, second fibers are also arranged along the transverse direction. In this example, it is in particular provided that only the second fibers are arranged along the transverse direction. These second fibers, which run along the transverse direction, are arranged in a certain rhythm above and below the fibers which run along the direction. The fibers may be arranged in relation to one another in accordance with a thread crossing. The first fibers and the second fibers arranged along the direction and the second fibers arranged along the transverse direction together form a fabric layer. This fabric layer includes the fibers which are arranged and crossed at right angles to one another. In one case, the can may be formed from a fabric layer of this kind. The formation of eddy currents is prevented within a fabric layer of this kind.

Furthermore, it is advantageous when the can is manufactured from at least two fabric layers arranged one above the other, wherein the at least two fabric layers are arranged one above the other along a radial direction of the can. If the can includes more than one fabric layer, the hybrid concept is expanded into the third dimension, (namely the radial direction or the thickness direction of the can), to form a laminate. In this example, it is likewise provided that there is a spatial separation between the first fibers or the electrically conductive fibers along the thickness direction of the can or the radial direction. For example, the fabric layer for manufacturing the can may accordingly be placed on a cylindrical mold and/or wound around the cylindrical mold. The can may have a variable thickness. This means that different regions of the can may have a different number of fabric layers.

In one embodiment, the at least two fabric layers arranged one above the other are configured in such a way that the first fibers from the respective fabric layers are spaced apart from one another. For example, the second fibers, which are arranged along the direction and transverse directions, may be configured or arranged such that the respective first fibers of the respective fabric layer do not touch when the fabric layers are arranged one above the other. The spatial separation in the thickness direction or in the radial direction may likewise be formed as a three-dimensional woven configuration or as a 3D fabric, wherein the electrical contact between the electrically conductive fibers in the axial direction and in the radial direction by the spatial separation from one another is achieved by weaving with the second fibers. Therefore, closing of the circuits in the radial direction or in the thickness direction of the can may be prevented.

According to a further embodiment, an electrically insulating layer is arranged between the at least two hybrid fabric layers which are arranged one above the other. This insulating layer may be provided, for example, by a very thin glass fabric layer which has a very low basis weight. The insulating layer may also be an electrically insulating film. For example, an electrically insulating layer of this kind may be arranged on the fabric layer during the production of the can. The composite including the fabric layer and the electrically insulating layer may then be placed and/or wound around a cylindrical mold. This allows simple production of the can, in which the eddy currents may be prevented in an effective manner.

The direction, along which the first fibers or the electrically conductive fibers run, may correspond to the circumferential direction of the can or of the electric machine. It may also be provided that the direction runs in the angular range between −70° and 70° in relation to the circumferential direction. By separating the first fibers or the electrically conductive fibers by the second fibers, closing of the eddy current circuits in the direction transverse in relation to the direction is suppressed. As a result, the electromagnetic losses associated with the induced eddy currents are reduced. The additional component heating associated with electrical heat is therefore likewise prevented.

In one embodiment, the first fibers are carbon fibers and the second fibers are glass fibers and/or aramid fibers and/or ceramic fibers. A high specific strength and rigidity may be achieved owing to the carbon fibers. The second fibers, which are manufactured from glass and/or aramid and/or ceramic, are likewise distinguished by the good specific mechanical properties. These materials are also electrically insulating.

An electric machine includes a can as disclosed herein. The electric machine may have a cooling device for cooling the stator. A cooling liquid for cooling the stator, (e.g., the coils of the stator), may be conveyed by the cooling device.

A method is used to produce a can for an electric machine, wherein the can is configured to be arranged between a stator and a rotor of the electric machine. Here, the can is manufactured at least partially from a fiber composite material which has a matrix and a plurality of fibers. In this example, the plurality of fibers includes first fibers manufactured from an electrically conductive, first material. Furthermore, the plurality of fibers includes second fibers manufactured from a second material which has a lower electrical conductivity in comparison to the first material. In this example, the first fibers and the second fibers are arranged in relation to one another in such a way that the respective first fibers are spaced apart from one another.

According to one embodiment, the production method for the can may proceed as follows: A fabric layer may be woven from the first fibers and the second fibers. This fabric layer may then be impregnated with the matrix material, (e.g., a resin). The pre-impregnated fabric layer may then be applied to a mold. In particular, the pre-impregnated fabric layer may be wound onto a cylindrical mold or placed on the cylindrical mold. If a plurality of fabric layers are provided one above the other, the electrically insulating layer may be arranged between the fabric layers. This electrically insulating layer may be a fabric layer with a very low basis weight and therefore a very small thickness. The composite including the hybrid fabric layers and optionally the electrically insulating layers, including the impregnating matrix material, may then be vented, (e.g., under vacuum), and then cured, (e.g., in an autoclave), under pressure and at elevated temperature. It would also be conceivable for the matrix material to be located only in the hybrid fabric layers, so that the matrix material wets the electrically insulating layers during the production process. The electrically insulating layers and the fabric layers may also be pre-impregnated. In addition, the cured material may accordingly be cut to length in order to produce the can. Other methods, (e.g., injection or pressing methods), may also be used to produce the can.

The embodiments presented with respect to the can and the advantages of the embodiments apply in a corresponding manner to the electric machine and to the method.

Further features of the disclosure may be found in the claims, the figures, and the description of the figures. The features and combinations of features cited above in the description and the features and combinations of features cited below in the description of the figures and/or shown in the figures alone may be used not only in the respectively indicated combination but also in other combinations, without departing from the scope of the disclosure.

### BRIEF DESCRIPTION OF THE DRAWINGS

The present disclosure will now be explained in more detail with reference to the accompanying drawings, in which:

FIG. 1 shows an illustration of a detail of an electric machine which has a stator, a rotor, and a can.

FIG. 2 shows a sectional illustration through a microscopic region of a unidirectional fiber composite layer of a can, which is configured according to the prior art as a fiber composite part.

FIG. 3 shows a schematic illustration which illustrates an example of the formation of the eddy currents in the can according to FIG. 2.

FIG. 4 shows a schematic representation of a fabric layer for producing the can according to one embodiment, wherein the fabric layer has first fibers and second fibers.

FIG. 5 shows a fabric layer according to a further embodiment.

FIG. 6 shows a fabric layer according to a further embodiment.

FIG. 7 shows a schematic illustration of an example of two fabric layers in a laminate, wherein the fabric layers are arranged one above the other along a radial direction of the can and are radially spaced apart by an additional insulating layer.

FIG. 8 shows a schematic illustration of an example of an arrangement of the fabric layer and an electrically insulating layer.

FIG. 9 shows an example of the layers according to FIG. 8 which are wound onto a cylindrical mold for producing the can.

Identical or functionally identical elements are provided with the same reference symbols in the figures.

### DETAILED DESCRIPTION

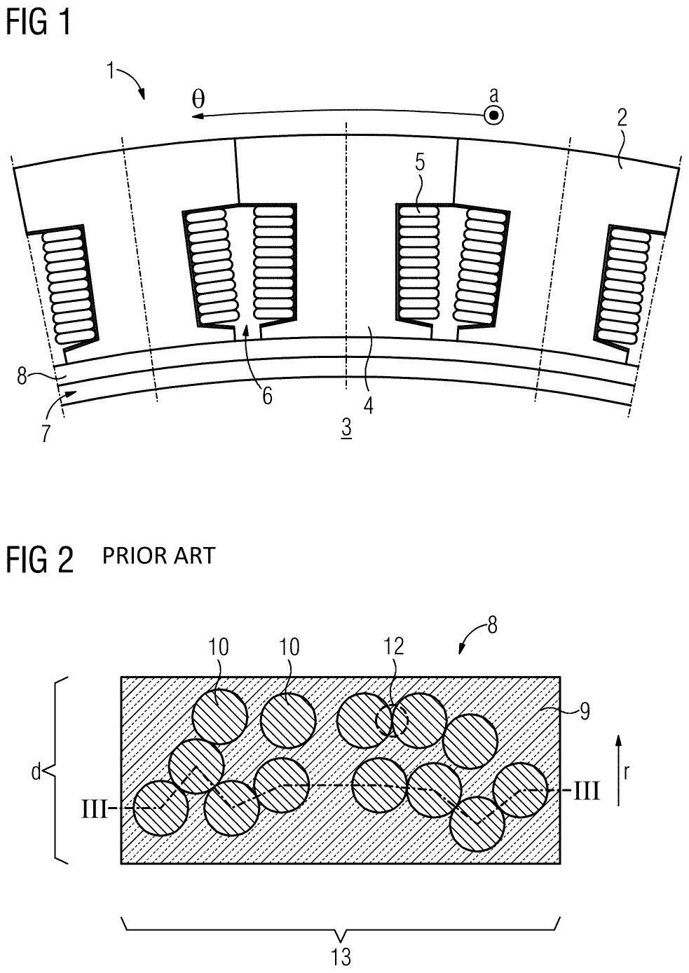

FIG. 1 shows a section through a circular sector of an electric machine 1. The electric machine 1 includes a stator 2 and a rotor 3, the outside diameter of which is only indicated here. The stator 2 includes a plurality of teeth 4 on which respective coils 5 of a winding of the electric machine 1 are arranged. The electric machine 1 or the stator 2 is of liquid-cooled design in the present case. This means that there is a cooling liquid between the teeth 4 in respective intermediate spaces 6. A mechanical air gap 7 is formed between the stator 2 and the rotor 3. A can 8 is provided in order to prevent the cooling liquid from the stator 2 from entering the air gap 7. This can 8 is of substantially hollow-cylindrical design.

FIG. 2 shows a microscopic section through a region of a fiber composite layer of a can 8 according to the prior art. This can 8 is formed from a fiber composite material and includes a matrix 9 and a plurality of first fibers 10. These first fibers 10 are formed from an electrically conductive material, (e.g., carbon). The matrix 9 is formed from an electrically insulating material. In this example, the first fibers 10 are arranged in relation to one another such that the first fibers 10 partially touch one another and therefore are in electrical contact with one another. FIG. 2 shows, by way of example, an electrical contact surface 12 between two adjacent first fibers 10. The region shown of the can 8 has a thickness d in the radial direction r which is significantly smaller than the total thickness of the can 8. In addition, an active region 13 is schematically illustrated.

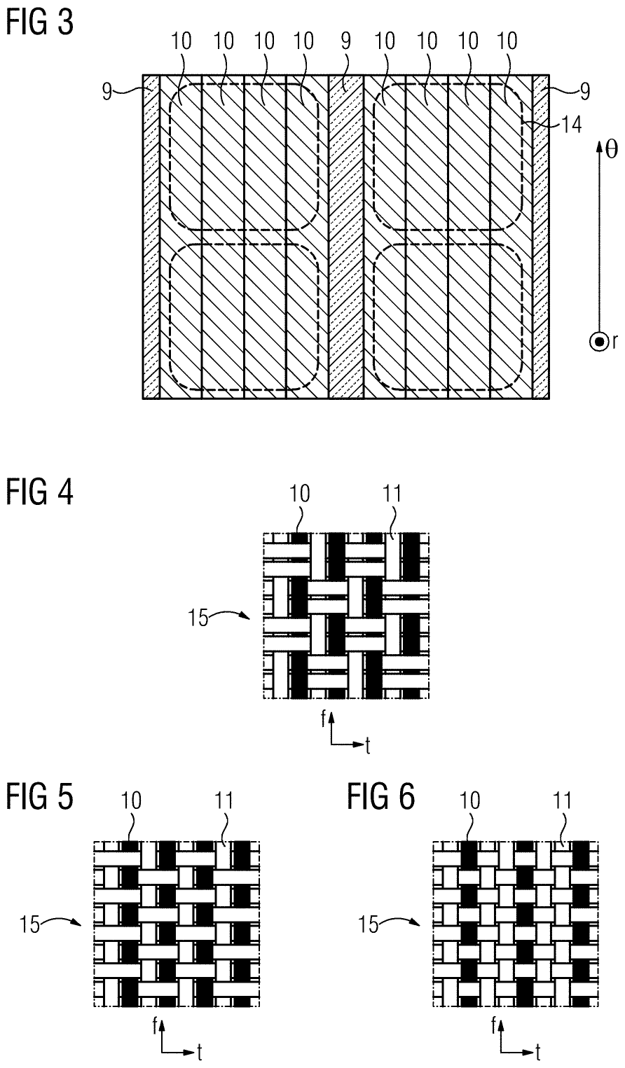

FIG. 3 shows a microscopic detail of the can according to section III-III indicated in FIG. 2. The respective first fibers 10 may be seen here, which first fibers are arranged parallel in relation to one another and in the present case run along a circumferential direction ⊖ of the can 8. It may be seen in this symbolic illustration that in each case four electrically conductive fibers 10 are in contact with one another along the section III-III. FIG. 3 shows a very rough, simplified illustration. The fibers 10 may have a diameter in the micrometer range. In reality, there is electrical contact between a number of fibers 10, which form a closed circuit, which is higher by orders of magnitude. Therefore, the active region 13 may extend over the axial length of the can 8. As a result, eddy currents may form in the can 8. The symbolic eddy current profile 14 is indicated in the present case.

FIGS. 4 to 6 show different embodiments of fabric layers 15 for producing a can 8 according to one embodiment. With these fabric layers 15, the electrical contact between the first fibers 10 or the electrically conductive fibers is to be suppressed. This is achieved in that, in addition to the first fibers 10, second fibers 11 which are manufactured from a second material are also used. This second material has a lower electrical conductivity than a first material from which the first fibers 10 are manufactured. In particular, the second material is an electrical insulator, (e.g., glass or aramid). In this example, the first fibers 10 and the second fibers 11 are connected to the fabric layer 15. The first fibers 10 and the second fibers 11 in particular each include a multiplicity of individual fibers. In this example, the first fibers 10 are arranged parallel in relation to one another and along a direction f. At least one second fiber 11 is arranged between two adjacent first fibers 10. In the examples of FIG. 4 and FIG. 5, a second fiber 11 is arranged between the first fibers 10 in each case. In the example of FIG. 6, two second fibers 11 are arranged between the adjacent first fibers in each case.

In addition, the respective fabric layers 15 include second fibers 11 arranged along a transverse direction t. In the present example, only second fibers 11 are arranged along the transverse direction t. In the case of the can 8, the direction f may correspond to the circumferential direction θ and the transverse direction t may correspond to the axial direction a of the can 8. Therefore, a hybrid fabric concept may be provided by which the creation of the eddy currents may be suppressed.

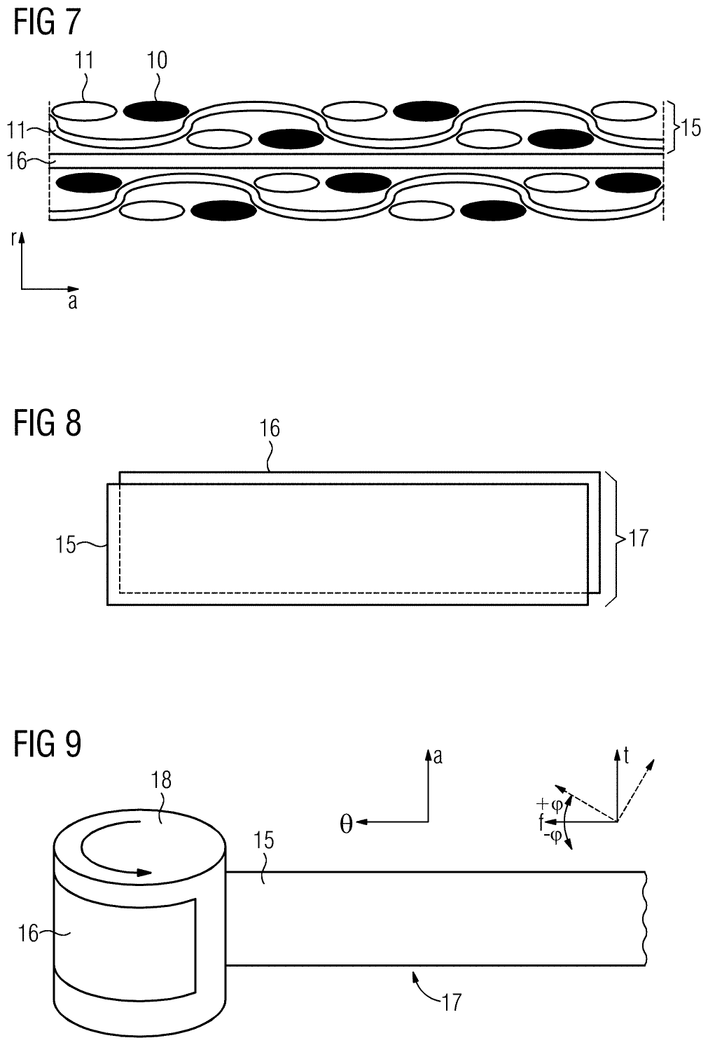

If the can 8 includes more than one fabric layer 15 of this kind, the hybrid concept is expanded into the third dimension or the radial direction r of the can 8 to form a laminate. As is schematically illustrated in FIG. 7, this may be achieved by using the previously described fabric layer 15, wherein an electrically insulating layer 16 is arranged between two fabric layers 15 which are arranged one above the other. The electrically insulating layer 16 may be a very thin electrically insulating fabric layer with a very low basis weight or a plastic film. In this specific example, the direction f of the respective fabric layers 15 points in the circumferential direction θ of the can 8 or of the electric motor 1. FIG. 7 also shows the second fibers 11 which run along the transverse direction t. These second fibers 11 run, for example, as is likewise indicated in FIG. 4 and FIG. 5, alternately above and below a pair including a first fiber 10 and a second fiber 11 which run along the direction f. In the present example, the transverse direction t corresponds to the axial direction a of the can 8.

FIG. 8 shows a schematic illustration of a composite 17 which includes a fabric layer 15 and an electrically insulating layer 16. The two layers 15, 16 are first joined together, for example, by vacuuming two respective prepreg material layers. The composite 17 is then applied to a mold 18 and manufactured in accordance with the corresponding process, for example in a temperature/pressure curing cycle in an autoclave.

The application of the composite 17 to the mold 18 is illustrated schematically in FIG. 9 in the present example. In this example, the mold 18 is of cylindrical design. The composite 17 is correspondingly wound onto this mold 18. In the example shown, the direction f corresponds to the circumferential direction θ of the can 8 and the transverse direction t corresponds to the axial direction a of the can 8. The direction f may lie at an angle φ of −70° to 70° in relation to the circumferential direction θ.

In the present example, there is hybridization of electrically conductive first fibers 10 and electrically insulating, second fibers 11 to form a fabric concept and the spatial separation of the electrically conductive fibers 10 or units achieved as a result. In addition, an analog three-dimensional expansion in the thickness direction or radial direction r of the can 8 is provided in order to suppress closing of the circuits transversely in relation to the conductive fibers (e.g., axial direction a of the can 8) and the resulting eddy current losses.

The electromagnetic properties are paramount given the advantages expected. By separating electrically conductive fibers or the first fibers 10 by electrically insulating fibers or the second fibers 11, closing of the eddy current circuits in the direction transverse in relation to the electrically conductive fibers is suppressed. As a result, the electromagnetic losses which are associated with induced eddy currents are reduced. In this example, the additional component heating which is associated with electrical heat is prevented. Overall, the robustness of the entire electric machine 1 system is improved.

Although the disclosure has been illustrated and described in greater detail by the exemplary embodiments, the disclosure is not restricted by these exemplary embodiments. Other variations may be derived herefrom by the person skilled in the art, without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A can configured to be arranged between a stator and a rotor of an electric machine, the can comprising:
a fiber composite material having a matrix and a plurality of fibers,
wherein the plurality of fibers comprises first fibers having an electrically conductive, first material,
wherein the plurality of fibers comprises second fibers having a second material having a lower electrical conductivity in comparison to the first material, and
wherein the first fibers and the second fibers are arranged in relation to one another in such a way that respective first fibers are spaced apart from one another.

2. The can of claim 1, wherein the first fibers are arranged parallel in relation to one another along a first direction, and
wherein at least one second fiber is arranged along the first direction between adjacent first fibers in each case.

3. The can of claim 2, wherein the first fibers and the second fibers form a first fabric layer in which a portion of the second fibers are additionally arranged along a transverse direction, which is perpendicular in relation to the first direction.

4. The can of claim 3, wherein the can comprises at least two fabric layers including the first fabric layer, and
wherein the at least two fabric layers are arranged one above the other along a radial direction of the can.

5. The can of claim 4, wherein the at least two fabric layers are configured in such a way that the first fibers from the respective fabric layers are spaced apart from one another.

6. The can of claim 4, wherein an electrically insulating layer is arranged between two fabric layers of the at least two fabric layers.

7. The can of claim 6, wherein the first direction runs in an angular range of between −70° and 70° in relation to a circumferential direction of the can.

8. The can of claim 1, wherein the first fibers are carbon fibers.

9. The can of claim 8, wherein the second fibers are glass fibers, aramid fibers, ceramic fibers, or a combination thereof.

10. An electric machine comprising:
a stator;
a rotor; and
a can comprising:
a fiber composite material having a matrix and a plurality of fibers,
wherein the plurality of fibers comprises first fibers having an electrically conductive, first material, and second fibers having a second material having a lower electrical conductivity in comparison to the first material, and
wherein the first fibers and the second fibers are arranged in relation to one another in such a way that respective first fibers are spaced apart from one another,
wherein the can is configured to be arranged between the stator and the rotor.

11. A method for producing a can for an electric machine, wherein the can is configured to be arranged between a stator and a rotor of the electric machine, the method comprising:
providing first fibers from an electrically conductive, first material;
providing second fibers from a second material having a lower electrical conductivity in comparison to the first material; and
forming the can at least partially from a fiber composite material having a matrix and a plurality of fibers, wherein the plurality of fibers comprises the first fibers and the second fibers,
wherein the first fibers and the second fibers are arranged in relation to one another in such a way that respective first fibers are spaced apart from one another.

12. The can of claim 2, wherein the first direction runs in an angular range of between −70° and 70° in relation to a circumferential direction of the can.

13. The can of claim 5, wherein the first direction runs in an angular range of between −70° and 70° in relation to a circumferential direction of the can.

14. The can of claim 2, wherein the first fibers are carbon fibers.

15. The can of claim 14, wherein the second fibers are glass fibers, aramid fibers, ceramic fibers, or a combination thereof.

16. The can of claim 1, wherein the second fibers are glass fibers, aramid fibers, ceramic fibers, or a combination thereof.
